(19) United States
(12) Patent Application Publication
(10) Pub. No.: US 2019/0353276 A1
(43) Pub. Date: Nov. 21, 2019

(54) PIEZOELECTRIC ACTUATOR, ABNORMALITY DETECTION CIRCUIT, AND PIEZOELECTRIC VALVE SYSTEM

(71) Applicants: SATAKE CORPORATION, Tokyo (JP); MECHANO TRANSFORMER CORPORATION, Tokyo (JP)

(72) Inventors: Takafumi ITO, Tokyo (JP); Hironori ARII, Tokyo (JP); Tadashi MATSUSHITA, Tokyo (JP); Sze Keat CHEE, Tokyo (JP); Takeshi YANO, Tokyo (JP)

(73) Assignees: SATAKE CORPORATION, Tokyo (JP); MECHANO TRANSFORMER CORPORATION, Tokyo (JP)

(21) Appl. No.: 16/479,013

(22) PCT Filed: Dec. 25, 2017
(86) PCT No.: PCT/JP2017/046488

§ 371 Date: Jul. 18, 2019

(30) Foreign Application Priority Data
Jan. 19, 2017 (JP) 2017-007397

(51) Int. Cl. F16K 37/00; H02N 2/02; H02N 2/06; B07C 5/36; F16K 31/00; G08B 21/18

(52) U.S. Cl. CPC F16K 37/0041; H02N 2/026; H02N 2/062; G08B 21/18; B07C 5/366; F16K 31/007; H02N 2/067

(57) ABSTRACT

The piezoelectric actuator includes a piezoelectric element; a power supply applying a voltage to the piezoelectric element; a drive circuit that applies a voltage from the power supply to the piezoelectric element by a pulse charge signal and a discharge signal to charge, and discharges the charge charged in the piezoelectric element to drive the piezoelectric element; an abnormality detection circuit that detects an abnormality due to insulation failure of the piezoelectric element, and a control unit that determines whether or not the piezoelectric element is normal based on an abnormality detection signal. The abnormality detection circuit outputs the abnormality detection signal that detects a time corresponding to a period from when a current starts to flow to the piezoelectric element during charging to when a current stops to flow, and it is determined that the piezoelectric element is abnormal when the time is equal to or more than a set time.

### TECHNICAL FIELD

The present invention relates to a piezoelectric actuator that performs a predetermined drive operation using displacement of a piezoelectric element, an abnormality detection circuit, and a piezoelectric valve system.

### BACKGROUND ART

With voltage being applied to a piezoelectric element, piezoelectric actuators that generate expansion and contraction displacement according to applied voltage have excellent points such as high energy efficiency, capable of high-speed response, and suitable for miniaturization and thinning, therefore being applied as driving devices in various fields.

For example, a piezoelectric valve using a piezoelectric actuator as a drive mechanism is known as a valve capable of high-speed response, and it has been proposed to use such a piezoelectric valve for an optical granular material sorter (for example, Patent Literature 1).

On the other hand, in such a piezoelectric actuator, impossibility of performing normal expansion and contraction operation due to abnormality of the piezoelectric element causes impossibility of performing normal operation of the piezoelectric actuator and also leads to damage to the power supply circuit and drive circuit that provide high voltage to drive the piezoelectric element, therefore it is desirable to quickly detect an abnormality in the piezoelectric element.

For this reason, an abnormality detection circuit is conventionally provided in a piezoelectric actuator used for a piezoelectric valve. For example, as shown in FIG. 8, a piezoelectric actuator has a drive circuit 402 charging a piezoelectric element 401 which is a capacitive element by applying a high voltage from a power supply (not shown) and discharging the charge charged to drive the piezoelectric element 401. When an abnormality such as insulation failure occurs in the piezoelectric element 401, a fuse resistor 403 provided in a feed line is broken, which is detected by an abnormality detection circuit 404, an abnormality detection signal being output to a control unit.

Furthermore, Patent Literatures 2 to 5 disclose techniques detecting an abnormality in a drive circuit including a piezoelectric element.

On the other hand, the applicant of the present invention has previously proposed, as a technology capable of detecting in advance an abnormality due to deterioration of the insulation characteristic of a piezoelectric element used in a piezoelectric actuator, one that includes an abnormality detection circuit connected to a ground side terminal of a piezoelectric element, and a switch connecting the ground side terminal of the piezoelectric element to an operation side line during operation of a piezoelectric actuator to lead to be a state in which the ground side terminal of the piezoelectric element is not connected to the operation side line when abnormality is detected by the abnormality detection circuit, and the abnormality detection circuit includes a grounded line connected to the ground side terminal of the piezoelectric element, a resistor provided in the middle of the line and connected in series to the piezoelectric element and an abnormality determination unit that detects a voltage based on the resistor and performs abnormality determination based on the voltage value (Japanese Patent Application No. 2015-185455 (Japanese Patent Application Laid-Open No. 2017-60356)).

### CITATION LIST

### Patent Literature

### [Patent Literature 1]

Japanese Patent Laid-Open No. 2004-316835

### [Patent Literature 2]

Japanese Patent Laid-Open No. 2002-10658

### [Patent Literature 3]

Japanese Patent Laid-Open No. 1-202177

### [Patent Literature 4]

Japanese Patent Laid-Open No. 2002-134804

### [Patent Literature 5]

Japanese Patent Laid-Open No. 2002-246667

### SUMMARY OF INVENTION

### Technical Problem

However, in the case of the abnormality detection circuit using the fuse resistor, when an alarm is displayed, it is necessary to shut down the device using the valve and replace the fuse resistor or the substrate. In addition, it is not known whether decrease in insulation resistance of the piezoelectric element or operation failure until the disconnect of the fuse resistor.

Furthermore, Patent Literatures 2 to 5 described above detect an abnormality such as disconnection or short circuit of a drive circuit including a piezoelectric element during operation of the device to which a piezoelectric actuator is applied, and do not detect an abnormality in a piezoelectric element itself, and a circuit configuration is also complicated.

Furthermore, in the case of the abnormality detection circuit using the abnormality determination unit of the prior application, although deterioration of the insulation characteristic of the piezoelectric element can be measured, it is necessary to stop the device during measurement, and continuous measurement cannot be performed. Therefore, even if the piezoelectric element or the substrate is broken during operation of the device, it cannot be detected. For this reason, an abnormality detection circuit during operation is also required, which increases the cost of parts. In addition, although a piezoelectric element often operates normally even when an insulation resistance is lowered, such an element is also determined to be abnormal.

Therefore, an object of the present invention aims to provide a piezoelectric actuator requiring no replacement of a fuse resistor in an abnormality detection circuit, having low parts cost, and capable of detecting only a piezoelectric element that does not operate normally, during operation of a device, an abnormality detection circuit used therein, and a piezoelectric valve system using the same.

### Solution to Problem

In order to solve the above-mentioned subject, a piezoelectric actuator of one embodiment of the present invention, includes a piezoelectric element generating a predetermined displacement by applying a voltage, a power supply applying a voltage to the piezoelectric element, a drive circuit that applies a voltage from the power supply to the piezoelectric element by a pulse charge signal and a discharge signal to charge the piezoelectric element, and discharges the charge charged in the piezoelectric element to drive the piezoelectric element, an abnormality detection circuit detecting an abnormality due to insulation failure of the piezoelectric element, and a control unit that sends the charge signal and the discharge signal to the drive circuit, and determines whether the piezoelectric element is normal based on an abnormality detection signal from the abnormality detection circuit, and makes an object perform a predetermined operation by displacing the piezoelectric element. The abnormality detection circuit outputs the abnormality detection signal that detects a time corresponding to a period from when a current starts to flow to the piezoelectric element during charging to when a current stops to flow, and it is determined that the piezoelectric element is abnormal when the time is equal to or more than a set time. The displacement of the piezoelectric element may be enlarged using a displacement enlarging mechanism.

An abnormality detection circuit according to an embodiment of the present invention, wherein a piezoelectric actuator includes a piezoelectric element generating a predetermined displacement by applying a voltage, a power supply applying a voltage to the piezoelectric element, a drive circuit that applies a voltage from the power supply to the piezoelectric element by a pulse charge signal and a discharge signal to charge the piezoelectric element, and discharges the charge charged in the piezoelectric element to drive the piezoelectric element, and a control unit that sends the charge signal and the discharge signal to the drive circuit, the abnormality detection circuit detecting an abnormality due to insulation failure of the piezoelectric element in the piezoelectric actuator, wherein the abnormality detection circuit outputs the abnormality detection signal that detects a time corresponding to a period from when a current starts to flow to the piezoelectric element during charging to when a current stops to flow, and it is determined that the piezoelectric element is abnormal when the time is equal to or more than a set time.

In the above two embodiments, the abnormality detection circuit includes a resistor provided on a feed line from the power supply to the piezoelectric element and a switching element outputting a current supplied based on the voltage drop when a current flows through the piezoelectric element during charging as an abnormality detection signal, and the piezoelectric element is determined to be abnormal when a time during which the abnormality detection signal is flowing is equal to or longer than the set time.

The switching element is preferably a transistor. Furthermore, the abnormality detection circuit may be provided with an RC circuit for adjusting the set time. In this case, the abnormality detection circuit can include two transistors as the switching element and two RC circuits respectively corresponding to the two transistors, and the set time can be set to 80 μsec. Furthermore, it is preferable to use an FPGA as the abnormality detection circuit.

In the first embodiment, it may further have an alarm generation device that generates an alarm according to a command from the control unit when the control unit determines that the piezoelectric element is abnormal based on the abnormality detection signal from the abnormality detection circuit.

A piezoelectric valve system according to an embodiment of the present invention, is a piezoelectric valve system used in an optical granular material sorter that sorts granular materials by an optical detection means and blows off the sorted granular materials by a jet air, including a plurality of piezoelectric valves that open and close the air jet discharge path by causing a predetermined displacement in a piezoelectric element, a power supply for applying a voltage to the piezoelectric element, a drive circuit that selectively applies a voltage from the power supply to the piezoelectric element by the pulse charge signal and the discharge signal to the piezoelectric element of the plurality of piezoelectric valves to charge the piezoelectric element and discharges the charge charged in the piezoelectric element to drive the piezoelectric element, the abnormality detection circuit of the second embodiment described above detecting an abnormality due to insulation failure of the piezoelectric element, and a control unit that sends the charge signal and the discharge signal corresponding to the piezoelectric element of each piezoelectric valve to the drive circuit and determines whether the piezoelectric element is normal based on an abnormality detection signal from the abnormality detection circuit. According to the above embodiment of the present invention, when the pulse charge signal and discharge signal are applied to the piezoelectric element from the drive circuit to drive the piezoelectric element, using the fact that the current value of the piezoelectric element with reduced insulation resistance increases by the abnormality detection circuit, the state is detected in which a current continues to flow in the charged state without being discharged even after a certain time has passed after a current starts to flow in the piezoelectric element by the charge signal and it is determined that the state is abnormal. Thus, during operation of the device, due to the low insulation resistance, a large amount of current flows and the expected voltage is not applied to both ends, so that only the piezoelectric element that does not operate normally can be detected quickly. Furthermore, being able to detect an abnormality without using a fuse resistor requires no replacement of the fuse resistor and can identify quickly the cause of the abnormality. Furthermore, the abnormality detection circuit of the present invention has a configuration similar to that of the conventional abnormality detection circuit using a fuse, and an additional circuit is not acquired to provide, therefore the number of parts such as transistors and relays can be reduced, and parts cost can be reduced.

### Advantageous Effects of Invention

The present invention can provide a piezoelectric actuator requiring no replacement of a fuse resistor in an abnormality detection circuit, having low parts cost, and capable of detecting only a piezoelectric element that does not operate normally, during operation of a device, an abnormality detection circuit used therein, and a piezoelectric valve system using the same.

### BRIEF DESCRIPTION OF DRAWINGS

FIG. 1 is a schematic view showing a piezoelectric actuator according to an embodiment of the present invention.

FIG. 2 is a diagram showing a charge signal and a discharge signal.

FIG. 3 is a view showing an example of an input signal, a voltage applied to the piezoelectric element, a current, and an abnormality detection signal (determination) in the case of a non-defective product in which a piezoelectric element operates normally when a double pre-pulse signal is input.

FIG. 4 is a view showing an example of an input signal, a voltage applied to the piezoelectric element, a current, and an abnormality detection signal (determination) in the case of a defective product in which the piezoelectric element does not operate normally when a double pre-pulse signal is input.

FIG. 5 is a diagram showing a configuration of a more preferable abnormality detection circuit in which the abnormality detection signal is optimized.

FIG. 6 is a side cross-sectional view of an optical granular material sorter having a valve system as an application of the piezoelectric actuator.

FIG. 7 is a schematic view showing an example of the structure of a piezoelectric valve applied to the valve system of FIG. 6.

FIG. 8 is a view showing a conventional piezoelectric actuator used for a piezoelectric valve.

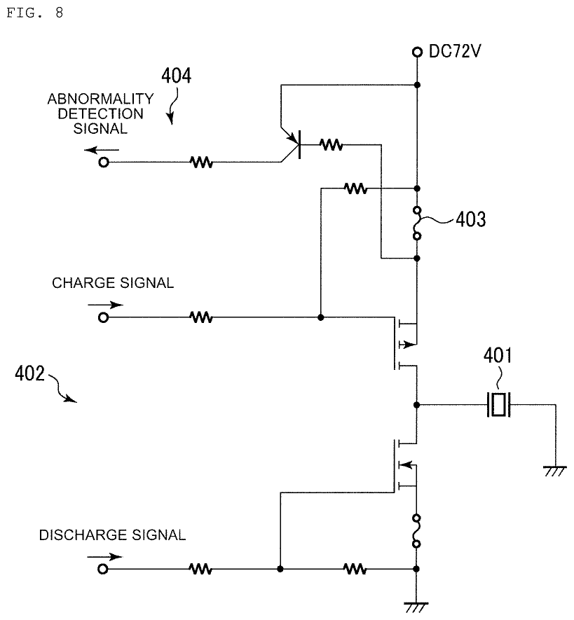

### DESCRIPTION OF EMBODIMENTS

Hereinafter, embodiments of the present invention will be described in detail.

### <Piezoelectric Actuator>

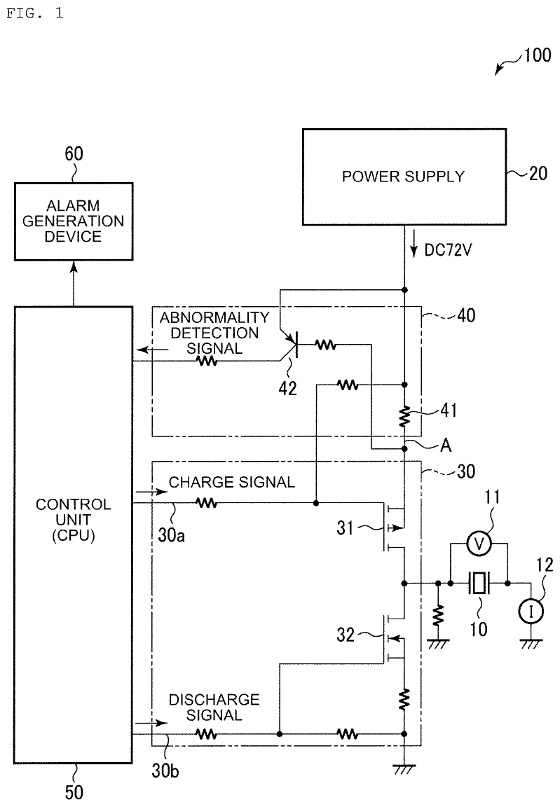

FIG. 1 is a schematic view showing a piezoelectric actuator according to an embodiment of the present invention. A piezoelectric actuator 100 according to the present embodiment is applied to a valve system used in an optical granular material sorter that sorts granular materials by an optical detection means and blows off the sorted granular materials by a jet air.

The piezoelectric actuator 100 includes a plurality of piezoelectric elements 10 (only one of which is shown) making expansion and contraction displacement by application of a voltage, a power supply 20 applying a high voltage to the piezoelectric elements 10, a drive circuit 30 charging and discharging the piezoelectric element 10 to drive the piezoelectric element, an abnormality detection circuit 40 detecting abnormality in the piezoelectric element 10 or the like, and a control unit (CPU) 50 that controls the drive circuit 30 and performs abnormality determination when an abnormality detection signal of the abnormality detection circuit 40 is input. An alarm generation device 60 is connected to the control unit 50.

The piezoelectric element 10 generates a predetermined displacement by applying a voltage, and a plurality of plate-like piezoelectric substances are stacked with an electrode interposed therebetween. A laminated piezoelectric element in which the expansion and contraction displacement occur by application of a voltage is preferably used. The material constituting a piezoelectric substance is an insulator (dielectric material), for example, lead zirconate titanate (Pb (Zr, Ti) O₃; PZT) can be used. Furthermore, the displacement of the piezoelectric element 10 may be enlarged by a displacement enlarging mechanism.

As will be described later, each piezoelectric element 10 is for driving a valve body of a piezoelectric valve, and four piezoelectric elements 10 form one unit, and a plurality of units are included. When applied to a piezoelectric valve system used in an optical granular material sorter, for example, 17 units of four piezoelectric elements 10 are disposed. A unit consisting of four piezoelectric elements 10 and valve bodies corresponding thereto or the like are housed in one case to constitute one valve unit. In the figure, 11 denotes a voltmeter for measuring the voltage applied to the piezoelectric element 10, and 12 denotes an ammeter for measuring a current flowing to the piezoelectric element 10.

A power supply 20 is a circuit that generates a high voltage necessary to drive the piezoelectric element 10, and when applied to a valve system used for an optical granular material sorter, for example, DC 72 V is used.

The drive circuit 30 receives a charge signal from the control unit 50 to a line 30a and a discharge signal to a line 30b, charges and discharges the piezoelectric element 10 based on the charge signal and the discharge signal to drive the piezoelectric element 10 to expand and contract. Specifically, the drive circuit 30 has a first switching element 31 and a second switching element 32 formed of a field effect transistor (FET). The first switching element 31 is turned on by the charge signal and the high voltage from the power supply 20 charges the piezoelectric element 10, and the second switching element 32 is turned on by the discharge signal, and the charge charged in the piezoelectric element 10 is discharged.

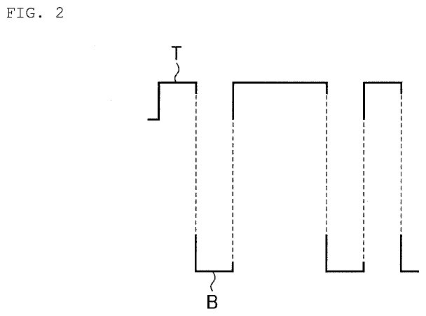

As shown in FIG. 2, the charge signal and the discharge signal are given as a pulse signal, the top T of the pulse is the charge signal, and the bottom B of the pulse is the discharge signal. When the piezoelectric actuator 100 is used in a valve system used in an optical granular material sorter, the charge signal and the discharge signal consist of a double pre-pulse and a main pulse. The double pre-pulse opens the valve body by applying a voltage to the piezoelectric element 10 by the first pre-pulse, and applies a voltage by the second pre-pulse according to the timing of an air ejection pressure fluctuation, and then applies a voltage by the input of the main pulse. The double pre-pulse is a signal for suppressing the pulsation of the valve body immediately after the valve opening and eliminating the fluctuation of an air jet amount (air ejection amount).

As the switching elements 31 and 32, relays or the like may be used instead of the FETs.

The abnormality detection circuit 40 is a circuit that generates a signal contradictory to the normal current behavior of the piezoelectric actuator 100 by a circuit and detects that the piezoelectric element 10 does not operate normally, and includes a resistor 41 provided on a feed line to the piezoelectric element 10 from the power supply 20 to the first switching element 31 and a transistor 42 as a switching element. The resistor 41 is provided instead of a conventionally provided fuse resistor.

When charging the piezoelectric element 10, a current flows from the power supply 20 to the piezoelectric element 10, and a voltage drop occurs at the resistor 41. The transistor 42 is turned on by the voltage drop and the setting condition of the circuit. When the piezoelectric element 10 operates normally, after the piezoelectric element 10 is charged when switched to the discharge, a current does not flow to the resistor 41. So that the transistor 42 is turned off in the time corresponding to the period in which a current flows.

On the other hand, when the piezoelectric element 10 does not operate normally due to insulation failure, the current value of the piezoelectric element 10 during charging becomes high, even after a certain time has passed after a current starts to flow a current continues to flow in the charged state without discharging, the state of current flowing to the point A downstream of the resistor 41 continues longer than the normal state, and the on-state time of the transistor 42 corresponding to that period (time during which a current flows in the transistor 42 continuously) continues for a long. The abnormality detection circuit 40 outputs a signal from the transistor 42 as an abnormality detection signal, and the piezoelectric element 10 is determined to be abnormal when the on-state time of the transistor 42 in the abnormality detection signal is longer than a set time set in advance.

The abnormality detection circuit 40 optimizes the constant of the circuit so that the set time of the abnormality detection signal becomes an appropriate value.

Although the transistor 42 is used as a switching element, a relay or the like may be used instead of the transistor.

The control unit 50 sends the charge signal and the discharge signal to the drive circuit 30 to control the drive of the piezoelectric element 10. Furthermore, when the abnormality detection signal of the abnormality detection circuit 40 is input, if the on time of the transistor 42 is shorter than the set time, the control unit 50 determines that the piezoelectric element 10, is operating normally, and if it is longer than the set time, the control unit 50 determines that the piezoelectric element 10 is abnormal. Then, when the control unit 50 determines that there is an abnormality, the control unit 50 sends an alarm generation command to the alarm generation device 60. In addition, the control unit 50 determines that the cable is not connected or disconnected when the on state of the transistor 42 does not appear in the abnormality detection signal even when the charge signal is input.

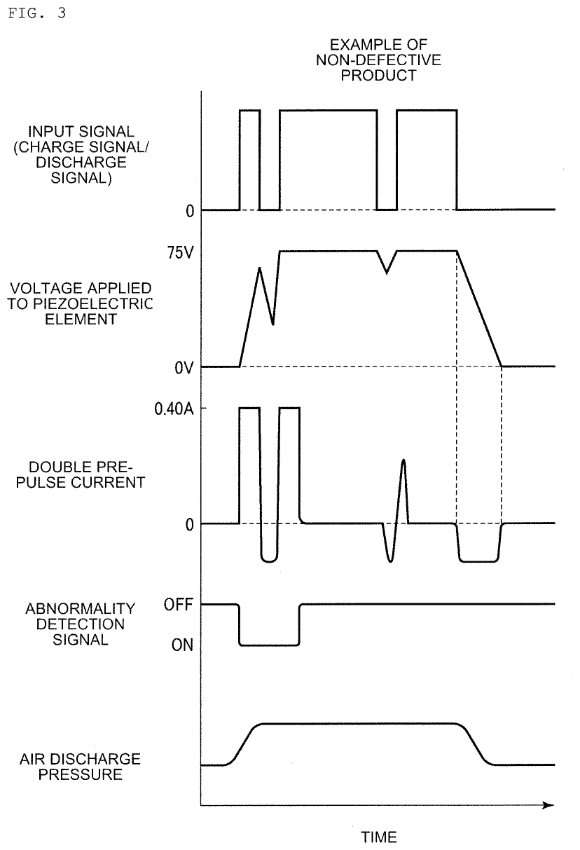

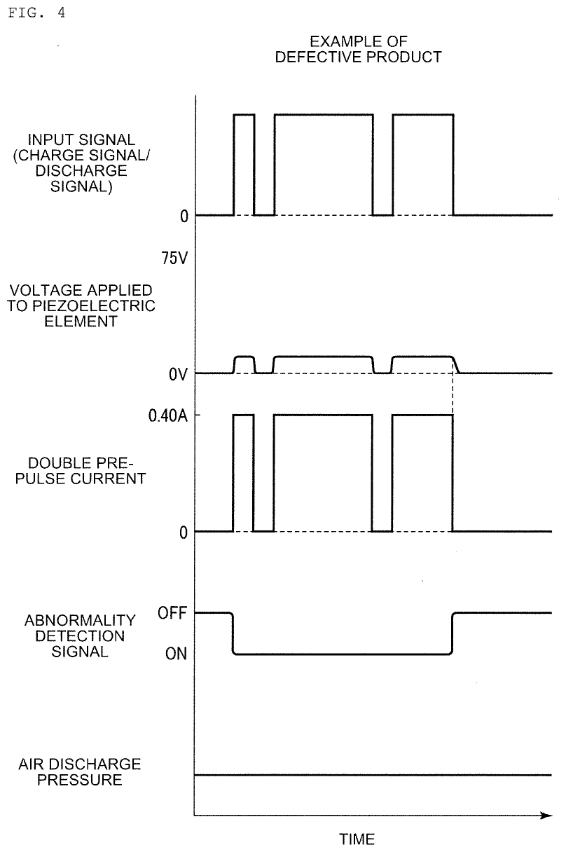

FIG. 3 and FIG. 4 show an example of determination results in the case of a non-defective product in which the piezoelectric element 10 operates normally when a double pre-pulse signal is input and in the case of a defective product not operating normally. FIG. 3 and FIG. 4 show an input signal (double pre-pulse control signal), the voltage applied to the piezoelectric element (value of voltmeter 11 of FIG. 1), double pre-pulse current (value of ammeter 12 of FIG. 1), abnormality detection signal (determination) and air pressure. The abnormality detection signal is a state in which a current flows at Low, that is, a state in which the transistor 42 is on.

When the piezoelectric element 10 is non-defective product, as shown in FIG. 3, a voltage of DC 75 V is applied to the piezoelectric element 10 during charging corresponding to the input signal, a double pre-pulse current flows correspondingly, and the transistor 42 becomes on state (in a state in which a current flows) by the charge signal to switch the abnormality detection signal from High to Low, but the Low period during which the transistor 42 is turned on and a current flows is short.

On the other hand, when the piezoelectric element 10 is a defective product, as shown in FIG. 4, the insulation resistance of the piezoelectric element 10 being lowered causes the voltage applied to both ends of the piezoelectric element 10 to be lower than that of the non-defective product, and a current to be higher than that of the non-defective product. Even if a certain period of time has passed after a current starts to flow in the piezoelectric element 10, a current keeps flowing in the charged state without discharging, and the Low period of the abnormality detection signal becomes long. Therefore, a predetermined set value is provided in the Low period of the abnormality detection signal, and if the Low period is longer than that, it can be determined as a defective product in which the piezoelectric element 10 does not operate normally. This set value can be optimized by incorporating an RC circuit in the abnormality detection circuit in the basic configuration of the abnormality detection circuit 40 shown in FIG. 1, adjusting its constant, and adjusting the number of transistors or the like.

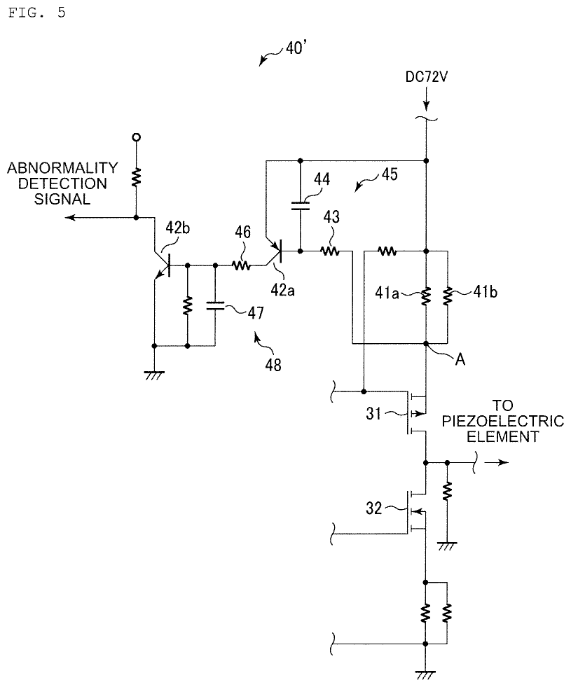

Hereinafter, a more preferable abnormality detection circuit in which the abnormality detection signal is optimized will be described more specifically. FIG. 5 is a diagram showing the configuration of such a more preferable abnormality detection circuit.

The abnormality detection circuit 40′ of FIG. 5 is used in a valve system in which a piezoelectric actuator is used in an optical granular material sorter, and detects abnormality of the piezoelectric element 10 when the above-described double pre-pulse control signal is given. It has resistors 41a and 41b provided in parallel to the line from the power supply 20 to the first switching element 31, and a first transistor 42a and a second transistor 42b as switching elements. In addition, a first RC circuit 45 consisting of a resistor 43 and a capacitor 44 is provided on the input side of the first transistor 42a and a second RC circuit 48 consisting of a resistor 46 and a capacitor 47 is provided on the input side of the second transistor 42b. As the abnormality detection circuit 40′, a high-speed and high-accuracy field-programmable gate array (FPGA) is used.

When the piezoelectric actuator is operated by the charge signal and the discharge signal, a current flowing by applying a voltage of 72 V from the power supply 20 causes the voltage drop due to the resistors 41a and 41b which are parallel resistors. The resistance of these resistors is 30.9Ω, and the voltage drop at this time is theoretically about 5.5 V at pre-pulse input and about 2 V at double pre-pulse input.

The occurrence of such voltage drop turns on the first transistor 42a and the second transistor 42b, and the abnormality of the piezoelectric element 10 is detected under the following conditions.

RC parameter (the value of the resistor 43 and the capacitor 44) of the first RC circuit 45: R=4.7 kΩ, C=0.1 μF
RC parameter (the value of the resistor 46 and the capacitor 47) of the second RC circuit 48: R=330 kΩ, C=0.01 μF
Abnormality detection condition: When a current flows continuously for approximately 80 μsec or more after a current flows to point A (from the time when electric charges are charged to the piezoelectric element 10) (that is, when the set value is 80 μsec)

The value of 80 μsec is determined by the RC circuit constant in the first RC circuit 45 and the second RC circuit 48 described above.

The validity of the value of 80 μsec is a length suitable for detecting an abnormal state of the piezoelectric element 10 by the FPGA with respect to the on/off pulse width (fixed value) of double pre-pulse, and is the value of the result of trial and error to prevent false detection due to noise at the same time.

In the abnormality detection circuit 40′ of this example, the time (time when the abnormality detection signal in FIG. 3 becomes Low) during which the first transistor 42a and the second transistor 42b are turned on and a current flows continuously is 80 μsec or more which is the set value, the control unit 50 determines that the piezoelectric element 10 is abnormal and issues an alarm command. However, a current change in less than 80 μsec is not detected, and is regarded as noise. On the other hand, when a current does not flow continuously for 80 μsec or more, the control unit 50 determines that the piezoelectric element 10 is normal and does not issue an alarm command. Also, in this case, a current change in less than 80 μsec is not detected, and is regarded as noise.

Furthermore, the control unit 50 determines that not only when described above, but also when the relation between the double pre-pulse control signal and the abnormality detection signal in FIG. 3 is other than the normal value (non-defective product), it is abnormal. For example, when the abnormality detection signal does not become Low even though the charge signal is given, the control unit 50 determines that the connection is not connected or disconnection.

According to the piezoelectric actuator 100 configured as described above, when the charge signal and discharge signal consisting of a pulse signal such as a double pre-pulse signal are supplied to the piezoelectric element 10 from the drive circuit 30 to drive the piezoelectric element 10, using the fact that the current value of the piezoelectric element with reduced insulation resistance increases by the abnormality detection circuit 40 or 40′, the state is detected in which a current continues to flow in the charged state without being discharged even after a certain time has passed after a current starts to flow in the piezoelectric element 10 by the charge signal, and it is determined that the state is abnormal. Thus, due to the low insulation resistance, a large amount of current flows and the expected voltage is not applied to both ends, so that only the piezoelectric element (valve) that does not operate normally can be detected quickly.

In the prior application (Japanese Patent Application No. 2015-185455 (Japanese Patent Laid-Open No. 2017-60356)), deterioration of the insulation characteristic of the piezoelectric element can be measured, but there is also a piezoelectric element that operates normally even if the insulation resistance is low and these elements are also determined as abnormal. Such elements are not likely to operate normally in the future, but may be revived with dry air. In this embodiment, it is possible to accurately determine that only the piezoelectric element that does not operate normally is abnormal.

Furthermore, in the prior application, it is necessary to determine the abnormality of the piezoelectric element in a state where the device is stopped, but in the present embodiment, the abnormality of the piezoelectric element can be detected continuously while operating the device. For this reason, it is possible to immediately detect and issue an alarm when an operation failure occurs in the piezoelectric element during the operation of the device.

Furthermore, no fuse resistor being used, there is no need to replace the fuse resistor, and the cause of the abnormality can be identified promptly.

Furthermore, the abnormality detection circuits 40, 40′ have a configuration similar to that of the conventional abnormality detection circuit only by using no fuse, and as in the prior application, an additional circuit is not acquired to provide in addition to them, therefore the number of parts such as transistors and relays can be reduced, and parts cost can be reduced.

### <Optical Granular Material Sorter>

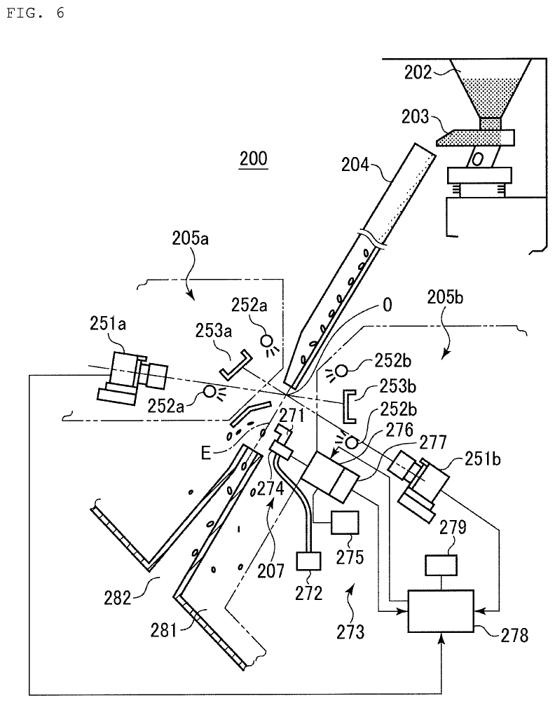

Next, as an application example of the above piezoelectric actuator, an optical granular material sorter having a piezoelectric valve system incorporating the piezoelectric actuator will be described. FIG. 6 is a side sectional view of an essential part showing the internal structure of a granular material sorter 200 in a simplified manner.

The granular material sorter 200 has a granular material supply unit consisting of a tank 202 and a vibrating feeder 203 at the top. A slanted chute 204 having a predetermined width is disposed below the granular material supply unit.

The granular material supplied from the granular material supply unit naturally flows down the slanted chute 204 continuously, and then discharged from the lower end part into the air along a predetermined falling trajectory.

In front and back of the predetermined falling trajectory E, at least a pair of optical detection devices 205a and 205b imaging the granular material at the detection position O along the falling trajectory E are disposed to face each other. Each of the optical detection devices 205a and 205b is constituted of imaging means 251a and 251b such as a CCD camera incorporating a CCD line sensor, illumination means 252a and 252b including a fluorescent lamp, and backgrounds 253a and 253b, and the like.

Furthermore, below the detection position O, a blowing device 207 is arranged which removes defective products or the like by air jet. The blowing device 207 has an air jet nozzle 271 having a plurality of nozzle holes, a compressed air supply device 272 sending compressed air to the air jet nozzle 271, and a piezoelectric valve system 273 switching the nozzle hole ejecting the air jet.

The piezoelectric valve system 273 includes a plurality of piezoelectric valves 274 having piezoelectric elements, a power supply 275 for applying a high voltage to the piezoelectric element, a drive circuit 276 for charging and discharging the piezoelectric element to drive the piezoelectric element and driving the piezoelectric valve 274 to open and close, an abnormality detection circuit 277 for detecting an abnormality in the piezoelectric element or the drive circuit 276, and a control unit 278 that controls drive circuit 276 and performs abnormality determination when an abnormality detection signal of the abnormality detection circuit 277 is input. An alarm generation device 279 is connected to the control unit 278. The drive circuit 276 and the abnormality detection circuit 277 can be configured in the same manner as the drive circuit 30 and the abnormality detection circuit 40 or 40′ in the piezoelectric actuator 100.

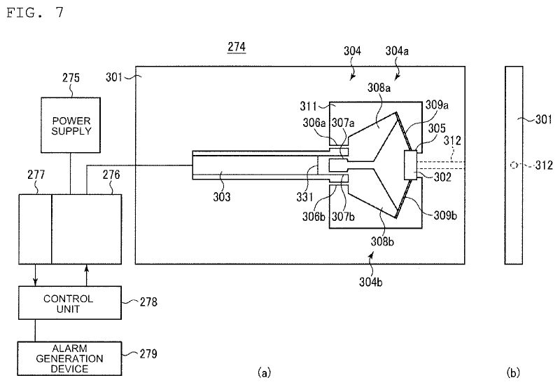

The piezoelectric valve 274 includes, as shown in the side view at the time of valve closing of FIG. 7(a) and the front view of FIG. 7(b), a pressure chamber 311 receiving compressed air from the compressed air supply device 272, and a valve main body 301 having a gas discharge path 312 for ejecting gas in the pressure chamber 311 to the outside, a valve body 302 for opening and closing the discharge path 312 disposed in the pressure chamber 311, a piezoelectric element 303 disposed in the valve main body 301 and fixed at one end to the valve main body 301, and a displacement enlarging mechanism 304 disposed in the gas pressure chamber 311 and expanding the displacement of the piezoelectric element 303 to act on the valve body 302. In the piezoelectric element 303, the piezoelectric element 303 is charged by the high voltage from the power supply 275 in response to the charge signal supplied from the drive circuit 276 described above, and the charge charged in the piezoelectric element 303 is discharged in response to the discharge signal supplied from the drive circuit 276. Thus, the piezoelectric element 303 is driven to expand and contract, and the valve body 302 is driven to open and close. Then, the valve body 302 is opened or closed by separating or seating the valve body 302 with respect to a valve seat 305 which is formed to protrude to the pressure chamber 311 side of the gas discharge path 312.

The displacement enlarging mechanism 304 has a first portion 304a and a second portion 304b symmetrically with respect to a line (hereinafter referred to as “center line”) connecting the longitudinal axis of the piezoelectric element 303 and the discharge path 312.

The first portion 304a of the displacement enlarging mechanism 304 is constituted of a first hinge 306a, a second hinge 307a, a first arm member 308a, and a first plate spring 309a. One end of the first hinge 306a is joined to the valve main body 301. One end of the second hinge 307a is joined to a cap member 331 attached to the piezoelectric element 303. Each of the other ends of the first hinge 306a and the second hinge 307a is joined to the base of the first arm member 308a. The first arm member 308a extends in the direction of the valve body 302 away from the center line, and one end of a first plate spring 309a is joined to the tip end portion of the first arm member 308a. The other end of the first plate spring 309a is joined to one side of the valve body 302.

On the other hand, the second portion 304b of the displacement enlarging mechanism 304 is constituted of a third hinge 306b, a fourth hinge 307b, a second arm member 308b, and a second plate spring 309b. One end of the third hinge 306b is joined to the valve main body 301. One end of the fourth hinge 307b is joined to a cap member 331 attached to the piezoelectric element 303. Each of the other ends of the third hinge 306b and the fourth hinge 307b is joined to the base of the second arm member 308b. The second arm member 308b extends in the direction of the valve body 302 away from the center line, and one end of the second plate spring 309b is joined to the tip end portion of the second arm member 308b. The other end of the second plate spring 309b is joined to the other side of the valve body 302.

Four piezoelectric valves 274 of such configuration are housed in one case to constitute one valve unit, and the piezoelectric valve system 273 has a plurality of, for example, 17 such valve units.

In the figure, 281 is a defective product discharge port, and 282 is a non-defective product discharge port.

Next, the operation of the optical granular material sorter 200 configured as described above will be described.

The granular material supplied from the granular material supply unit spreads in the width direction of the slanted chute 204 and naturally flows down continuously, and then is discharged from the lower end into the air along a predetermined falling trajectory. Then, the released granular material is imaged by the imaging means 251a and 251b of each of the optical detection devices 205a and 205b at the granular material detection position O, and the imaging data is sent to the control unit 278 of the piezoelectric valve system 273 in the blowing device 207. The control unit 278 specifies granular material to be removed such as a defective product based on the imaging data, acquires information on the size or the like of the granular material, and sends a removal signal for the defective product or the like to the drive circuit 276.

The drive circuit 276 selectively drives the plurality of piezoelectric valves 274 in the piezoelectric valve system 273 based on the sent removal signal according to a command from the control unit 278, and blows air from each nozzle hole of the air jet nozzle 271 provided corresponding to each position in the width direction with respect to a defective product or the like passing a granular material removal position E extending linearly in parallel with the width direction of the slanted chute 204.

Then, a defective product or the like blown off by the jet air from each nozzle hole of the air jet nozzle 271 is discharged from the defective product discharge port 281 to the outside of the machine. In addition, non-defective products or the like that have passed the predetermined falling trajectory without being blown off by the jet air are collected from the non-defective product discharge port 282.

At this time, in the piezoelectric valve 274, when the voltage from the power supply 275 is applied to the piezoelectric element 303 by the charge signal from the drive circuit 276 in the closed state of FIG. 7(a), the piezoelectric element 303 extends in the right direction in the drawing. With this extension, in the first portion 304a of the displacement enlarging mechanism 304, the second hinge 307a acts as a force point, the first hinge 306a acts as a fulcrum, and the tip of the first arm member 308a acts as an action point. The amount of displacement of the piezoelectric element 303 appears to be enlarged by the principle of leverage at the tip of the first arm member 308a. Similarly, in the second portion 304b, the fourth hinge 307b acts as a force point, the third hinge 306b acts as a fulcrum, and the tip of the second arm member 308b acts as an action point, and the amount of displacement of the piezoelectric element 303 appears to be enlarged at the tip of the second arm member 308b.

Then, the displacement that is expanded and appears in a direction in which each tip of the first arm member 308a and the second arm member 308b is separated spaces the valve body 302 a sufficient distance from the valve seat 305 via the first plate spring 309a and the second plate spring 309b to create a large gap between the valve body 302 and the valve seat 305. Thus, the piezoelectric valve 274 is opened, a sufficient amount of air is guided from the pressure chamber 311 through the discharge path 312 to the nozzle hole of the air jet nozzle 271, and the air is blown from the nozzle hole.

On the other hand, when a discharge signal is sent from the drive circuit 276, the piezoelectric valve 274 discharges and contracts from the expanded state of the piezoelectric element 303, and the valve body 302 is seated on the valve seat 305. At this time, the return force of the first plate spring 309a and the second plate spring 309b that a spring intrinsically has acts on the valve body 302 in the piezoelectric valve 274, and hence the valve body 302 can be reliably seated on the valve seat 305.

Thus, in the piezoelectric valve system 273 having a plurality of piezoelectric valves 274, the pulse charge signal and discharge signal are given to the piezoelectric elements 303 of the plurality of piezoelectric valves 274, and the piezoelectric valve 274 is opened and closed. For example, when the double pre-pulse control signal is given to the piezoelectric element via the drive circuit 276, when the insulation property of the piezoelectric element 303 of any piezoelectric valve 274 in the piezoelectric valve system 273 decreases, the abnormality detection circuit 277 detects a state in which a current continues to flow in the charged state without being discharged even after a certain time has passed after a current starts to flow in the piezoelectric element by the charge signal, and it is determined that the state is abnormal.

Thus, due to the low insulation resistance, a large amount of current flows and the expected voltage is not applied to both ends, and only the piezoelectric valve 274 corresponding to the piezoelectric element that does not operate normally can be detected quickly. Furthermore, the abnormality detection circuit 277 can continuously detect the abnormality of the piezoelectric element during the operation of the optical granular material sorter. When an operation failure occurs in the piezoelectric element during operation, it can be immediately detected and an alarm can be issued.

Furthermore, using no fuse resistor needs no replacement of the fuse resistor, and the cause of the abnormality can be promptly identified. Furthermore, the abnormality detection circuit 277 has a configuration similar to that of the conventional abnormality detection circuit only by using no fuse, and an additional circuit is not acquired, therefore the number of parts such as transistors and relays can be reduced, and parts cost can be reduced.

### Other Application

As mentioned above, although embodiment of this invention was described, the present invention is not limited to the above embodiment and can be variously modified. For example, in the above embodiment, the piezoelectric valve system of the optical granular material sorter is mentioned as an application example of the piezoelectric actuator according to the present invention, but the present invention is not limited to this, and is applicable as long as a piezoelectric element is used as a drive mechanism. Furthermore, the present invention is not limited to the case of having a plurality of piezoelectric elements, and may be a piezoelectric actuator having only one piezoelectric element.

In addition, the displacement enlarging mechanism is not limited to the structure shown in FIG. 7, and various types of displacement enlarging mechanisms in which the hinge and the arm are combined variously can be used.

### REFERENCE SIGNS LIST

10 piezoelectric element

20 power supply

30 drive circuit

31, 32 switching elements

40 abnormality detection circuit

41, 41a, 41b resistors

42, 42a, 42b transistors

45, 48 RC circuits

50 control unit

60 alarm generation device

100 piezoelectric actuator

200 optical granular material sorter

205a, 205b optical detection devices

207 blowing device

271 air jet nozzle

272 compressed air supply device

273 piezoelectric valve system

274 piezoelectric valve

275 power supply

276 drive circuit

277 abnormality detection circuit

278 control unit

301 valve main body

302 valve body

303 piezoelectric element

304 displacement enlarging mechanism

305 valve seat

1: A piezoelectric actuator, comprising:
a piezoelectric element generating a predetermined displacement by applying a voltage;
a power supply applying a voltage to the piezoelectric element;
a drive circuit that applies a voltage from the power supply to the piezoelectric element by a pulse charge signal and a discharge signal to charge the piezoelectric element, and discharges the charge charged in the piezoelectric element to drive the piezoelectric element;
an abnormality detection circuit detecting an abnormality due to insulation failure of the piezoelectric element; and
a control unit that sends the charge signal and the discharge signal to the drive circuit, and determines whether or not the piezoelectric element is normal based on an abnormality detection signal from the abnormality detection circuit,
and the piezoelectric actuator making an object perform a predetermined operation by displacing the piezoelectric element,
wherein the abnormality detection circuit outputs the abnormality detection signal that detects a time corresponding to a period from when a current starts to flow to the piezoelectric element during charging to when a current stops to flow, and it is determined that the piezoelectric element is abnormal when the time is equal to or more than a set time.

2: The piezoelectric actuator according to claim 1, wherein the abnormality detection circuit includes a resistor provided on a feed line from the power supply to the piezoelectric element and a switching element outputting a current supplied based on the voltage drop when a current flows through the piezoelectric element during charging as the abnormality detection signal, and the piezoelectric element is determined to be abnormal when a time during which the abnormality detection signal is flowing is equal to or longer than the set time.

3: The piezoelectric actuator according to claim 2, wherein the switching element is a transistor.

4: The piezoelectric actuator according to claim 3, wherein the abnormality detection circuit includes an RC circuit for adjusting the set time.

5: The piezoelectric actuator according to claim 4, wherein the abnormality detection circuit includes two transistors as the switching element and two RC circuits respectively corresponding to the two transistors, and the set time is set to 80 μsec.

6: The piezoelectric actuator according to claim 3, wherein an FPGA is used as the abnormality detection circuit.

7: The piezoelectric actuator according to claim 1, further comprising an alarm generation device that generates an alarm according to a command from the control unit when the control unit determines that the piezoelectric element is abnormal based on the abnormality detection signal from the abnormality detection circuit.

8: The piezoelectric actuator according to claim 1, wherein the piezoelectric actuator has a plurality of the piezoelectric elements, and each of the piezoelectric elements is used to open and close each of a plurality of valves used in an optical granular material sorter.

9: The piezoelectric actuator according to claim 1, further comprising a displacement enlarging mechanism enlarging displacement of the piezoelectric element.

10: An abnormality detection circuit, wherein a piezoelectric actuator comprising: a piezoelectric element generating a predetermined displacement by applying a voltage; a power supply applying a voltage to the piezoelectric element; a drive circuit that applies a voltage from the power supply to the piezoelectric element by a pulse charge signal and a discharge signal to charge the piezoelectric element, and discharges the charge charged in the piezoelectric element to drive the piezoelectric element; and a control unit that sends the charge signal and the discharge signal to the drive circuit, the abnormality detection circuit detecting an abnormality due to insulation failure of the piezoelectric element in the piezoelectric actuator, wherein
the abnormality detection circuit outputs an abnormality detection signal detecting a time corresponding to a period from when a current starts to flow to the piezoelectric element during charging to when a current stops to flow, and it is determined that the piezoelectric element is abnormal when the time is equal to or more than a set time.

11: The abnormality detection circuit according to claim 10, comprising: a resistor provided on a feed line from the power supply to the piezoelectric element; and a switching element outputting a current supplied based on the voltage drop when a current flows through the piezoelectric element during charging as the abnormality detection signal, wherein the piezoelectric element is determined to be abnormal when a time during which the abnormality detection signal is flowing is equal to or longer than the set time.

12: The abnormality detection circuit according to claim 11, wherein the switching element is a transistor.

13: The abnormality detection circuit according to claim 12, comprising an RC circuit for adjusting the set time.

14: The abnormality detection circuit according to claim 13, further comprising two transistors as the switching elements and two RC circuits respectively corresponding to the two transistors, wherein the set time is set to 80 μsec.

15: The abnormality detection circuit according to claim 12, wherein an FPGA is used as the abnormality detection circuit.

16: A piezoelectric valve system used in an optical granular material sorter that sorts granular material by an optical detection means and blows off the sorted granular material by a jet air, the piezoelectric valve system comprising:
a plurality of piezoelectric valves that open and close the air jet discharge path by causing a predetermined displacement in a piezoelectric element;
a power supply for applying a voltage to the piezoelectric element;
a drive circuit that selectively applies a voltage from the power supply to the piezoelectric element by a pulse charge signal and a discharge signal to the piezoelectric element of the plurality of piezoelectric valves to charge the piezoelectric element, and discharges the charge charged in the piezoelectric element to drive the piezoelectric element;
the abnormality detection circuit according to claim 10 detecting an abnormality due to insulation failure of the piezoelectric element; and
a control unit that sends the charge signal and the discharge signal corresponding to the piezoelectric element of each piezoelectric valve to the drive circuit and determines whether the piezoelectric element is normal or not based on an abnormality detection signal from the abnormality detection circuit.
